(19) United States
(12) Patent Application Publication
(10) Pub. No.: US 2013/0063433 A1
(43) Pub. Date: Mar. 14, 2013

(54) METHOD AND SYSTEM OF RENDERING WELL LOG VALUES

(71) Applicant: Jing-Rong Lin, Sugar Land, TX (US)

(72) Inventor: Jing-Rong Lin, Sugar Land, TX (US)

(73) Assignee: LANDMARK GRAPHICS CORPORATION, Houston, TX (US)

(21) Appl. No.: 13/699,382

(22) PCT Filed: May 27, 2010
(86) PCT No.: PCT/US10/36296

§ 371 Date: Nov. 21, 2012

(51) Int. Cl. G06T 11/20; G06T 15/00

(52) U.S. Cl. 345/419; 345/442

(57) ABSTRACT

Rendering well log values. At least some of the illustrative embodiments are methods that involve: sending to a graphics processing unit (GPU) of a computer system vertices that define a panel, the sending by a main processor of the computer system, the main processor distinct from the GPU; sending a program to the GPU, the sending of the program by the main processor; sending a first set of well log values to the GPU, the sending of the first set of well log values by the main processor; executing the program by the GPU which program determines a first curve from the first set of well log values by the program executed by the GPU; and displaying on a display device of the computer system the first curve within the panel.

### BACKGROUND

In the continuing advancements in recovery of natural resources, such as oil and natural gas trapped in underground formations, many companies use computer systems to help synthesize and understand data gathered regarding a well. Such synthesis assists geologists in making determinations such as the best reservoir extraction technique, and best location at which to extract the natural resources.

In many cases, data regarding a well, or multiple wells, are displayed on the display device of a computer system in such a way as to not only show the three dimensional direction of the well (projected in the two dimensions of the display device), but also in such a way that changes in the field of view are animated to simulate a “smoothly” changing scene (e.g., greater than about 20 frames per second) in transitions from one field of view to the next. However, the number of memory objects stored in display memory used to render even a single set of log data is enormous, stretching the limits of graphics capabilities of currently available graphics systems. The problems are exacerbated when a user desires to show in the same frame portions of well log values of multiple types or from multiple wells.

Thus, any advance in the synthesis and visualization of data for one or more wells would provide a competitive advantage in the market place.

### BRIEF DESCRIPTION OF THE DRAWINGS

For a detailed description of exemplary embodiments, reference will now be made to the accompanying drawings in which:

FIG. 1 shows a perspective view an illustrative trajectory of a wellbore;

FIG. 2 shows a portion of a well log in accordance with at least some embodiments;

FIG. 3 shows a computer system in accordance with at least some embodiments;

FIG. 4 shows a software environment in accordance with at least some embodiments;

FIG. 5 shows a constructing a curve of well log values using underlying geometry;

FIG. 6 shows a series of panels, as well as a first set of well log values and a curve program, in accordance with at least some embodiments;

FIG. 7 shows a series of panels showing a trajectory of a wellbore in accordance with at least some embodiments;

FIG. 8 shows a panel with a curve in accordance with at least some embodiments;

FIG. 9 shows a panel with multiple curves rendered therein in accordance with at least some embodiments;

FIG. 10 shows a panel with multiple curves rendered therein in accordance with at least some embodiments; and

FIG. 11 shows a method in accordance with at least some embodiments.

### NOTATION AND NOMENCLATURE

Certain terms are used throughout the following description and claims to refer to particular system components. As one skilled in the art will appreciate, software companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

“Wellbore” shall mean a hole drilled into the Earth's crust used directly or indirectly for the exploration or extraction of natural resources, such as oil, natural gas or water.

“Panel” shall mean a surface defined by vertices. A panel defines only a location, and does not define the pattern, color and/or illumination of pixels within the panel. Consider, as an example, a panel in the form of a rectangular face of a cubic volume. The panel defines only the rectangular face, and not the pattern, color and/or illumination of pixels within the panel.

“Well log values” shall mean a plurality of values of an attribute of one or more earth formation penetrated by a wellbore.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The various embodiments are directed to mechanisms to display or “visualize” well log values associated with wellbores that penetrate Earth formations. For ease of description, the various embodiments are discussed in terms of a single wellbore penetrating one or more Earth formations. The single wellbore has associated therewith at least one set of well log values, where each set of well log values represents a physical parameter associated with the formation penetrated by the wellbore or the wellbore itself. However, the various embodiments may also be used to display well log values from multiple wellbores, and thus the nature of the description shall not be read as a limitation as to the applicability of the various embodiments.

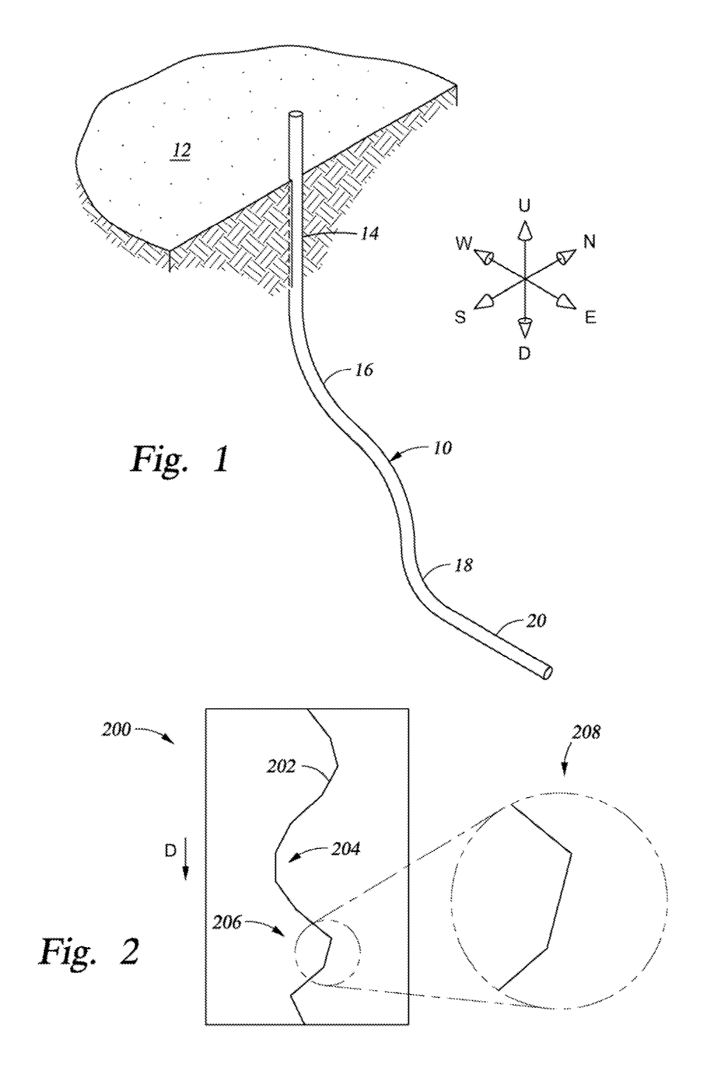

FIG. 1 illustrates a wellbore 10, which wellbore 10 may be drilled into the Earth for purposes of exploration and/or extraction of natural resources, such as hydrocarbons (e.g., oil and gas) and water. The balance of this description assumes wellbore 10 is drilled for purposes of exploration and/or extraction of hydrocarbons, but such assumption shall not be read to limit the techniques described only to hydrocarbon exploration. Moreover, it is noted that the wellbore 10 need not itself be a hydrocarbon producing wellbore. In some case, wellbores are drilled for exploratory purposes, or for other purposes that aid in the extraction of hydrocarbons, such as injection wells. Illustrative wellbore 10 has a trajectory (i.e., a three-dimensional path through the underlying Earth formation(s)) that can be considered to start at the surface 12 of the Earth. Initially, the illustrative wellbore 10 is substantially vertical, as illustrated by portion 14. After extending some distance into the Earth, the illustrative wellbore 10 turns toward the East and the downward slope decreases, as indicated by portion 16. Thereafter, the downward slope of the illustrative wellbore 10 increases again, as illustrated by portion 18. The slope of the illustrative wellbore 10 then decreases to the point where the wellbore 10 is substantially horizontal, as illustrated by portion 20. While illustrative wellbore 10 has no trajectory change from the East direction, the wellbore 10 may likewise change trajectory in any three-dimensional direction.

At various times during creation of the wellbore 10, data regarding physical parameters of the one or more formations penetrated by the wellbore may be gathered. For example, the drill string that creates wellbore 10 may include measuring-while-drilling or logging-while-drilling devices that read physical parameters of the formations as the drill bit creates the wellbore 10. Further, at various times during the drilling process the drill string may be removed from the wellbore 10, and a wireline logging tool run therein, where the wireline logging tool gathers data regarding the physical parameters of the formations penetrated by the wellbore 10. Further still, after drilling is complete and wellbore 10 is cased, additional logging tools may be run in the wellbore 10.

The type of data sets created by the data gathering processes also varies. For example, the various tools may measure physical parameters of the formations as a function of depth, such as porosity, electrical resistivity (reciprocal of conductivity), density, natural gamma production, responses to neutron interrogation, and capture cross-section. Moreover, the physical parameters of some data sets may provide information regarding lithology of the Earth formations. Further still, the physical parameters of some data sets may provide information regarding properties of the wellbore itself as a function of depth, such as casing thickness, cement thickness, and casing bond impedance.

Regardless of the precise nature of the parameters that a particular data set contains, in order to be useful the data sets are presented to geologist or other interested party by way of display device of a computer system in a form known as a log. FIG. 2 shows an illustrative view of a portion of a log for purposes of discussion. In particular, log 200 comprises curve 202, which curve 202 shows the value of a parameter based on the depth D within a wellbore, with depth D illustratively increasing downward. For example, for increasing values of the parameter, the curve 202 shifts to the left (e.g., portion 204), and for decreasing values of the parameter, the curve 202 shifts to the right (e.g., portion 206). Taking the parameter of the log 200 to be measured porosity of the formation, the porosity of the formation is higher at the depth associated with portion 204, and lower at the depth associated with portion 206. From the view point of FIG. 2, or alternatively stated at the magnification of illustrative FIG. 2, the curve 202 appears to be somewhat smoothly varying. However, the curve 202 is constructed based on discrete points of underlying well log values, with straight lines extending between each discrete point, as illustrated by the magnified region 208. Thus, the curve 202 as illustrated is piecewise linear.

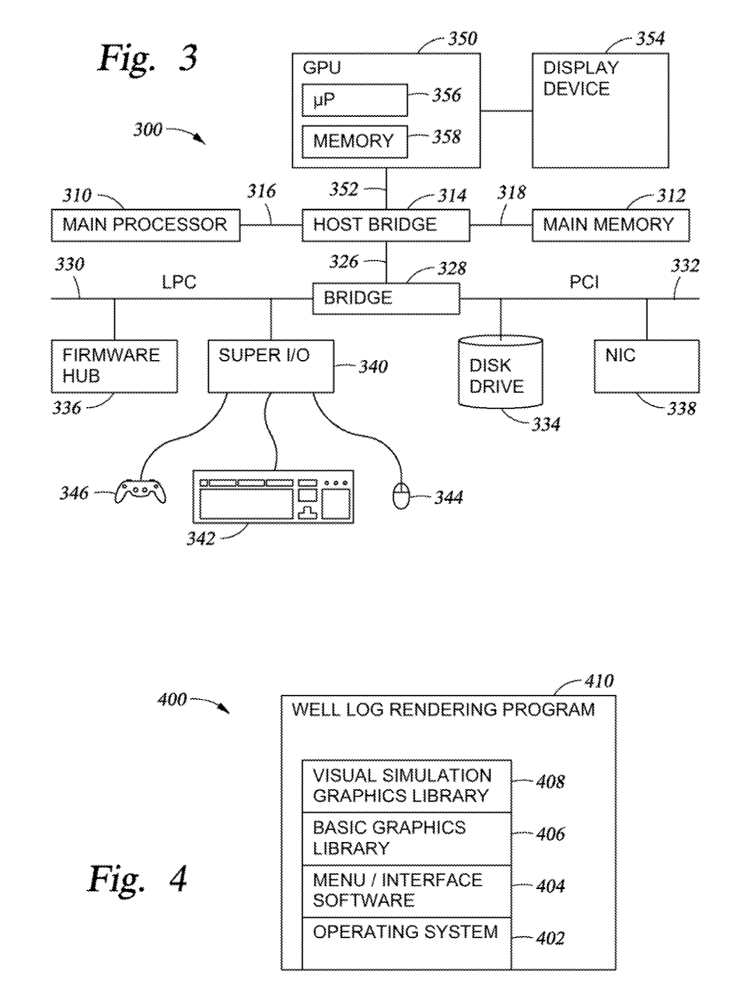

In order to describe the interactions between various processors of a computer system to implement the display of curves in accordance with the various embodiments, the specification now turns to an illustrative computer system. FIG. 3 illustrates a computer system 300 in accordance with at least some embodiments. In particular, computer system 300 comprises a main processor 310 coupled to a main memory array 312, and various other peripheral computer system components, through integrated host bridge 314. Computer system 300 may implement multiple main processors 310. The main processor 310 couples to the host bridge 314 by way of a host bus 316, or the host bridge 314 may be integrated into the main processor 310. Thus, the computer system 300 may implement other bus configurations or bus-bridges in addition to, or in place of, those shown in FIG. 3.

The main memory 312 couples to the host bridge 314 through a memory bus 318. Thus, the host bridge 314 comprises a memory control unit that controls transactions to the main memory 312 by asserting control signals for memory accesses. In other embodiments, the main processor 310 directly implements a memory control unit, and the main memory 312 may couple directly to the main processor 310. The main memory 312 functions as the working memory for the main processor 310 and comprises a memory device or array of memory devices in which programs, instructions and data are stored. The main memory 312 may comprise any suitable type of memory such as dynamic random access memory (DRAM) or any of the various types of DRAM devices such as synchronous DRAM (SDRAM), extended data output DRAM (EDODRAM), or Rambus DRAM (RDRAM). The main memory 312 is an example of a non-transitory computer-readable medium storing programs and instructions, and other examples are disk drives and flash memory devices.

The illustrative computer system 300 also comprises a second bridge 328 that bridges the primary expansion bus 326 to various secondary expansion buses, such as a low pin count (LPC) bus 330 and peripheral components interconnect (PCI) bus 332. Various other secondary expansion buses may be supported by the bridge device 328. However, computer system 300 is not limited to any particular chip set manufacturer, and thus bridge devices and expansion bus protocols from any of a variety of manufacturers may be equivalently used.

Firmware hub 336 couples to the bridge device 728 by way of the LPC bus 332. The firmware hub 334 comprises read-only memory (ROM) which contains software programs executable by the main processor 710. The software programs comprise programs executed during and just after power on self tests (POST) procedures as well as memory reference code. The POST procedures and memory reference code perform various functions within the computer system before control of the computer system is turned over to the operating system.

The computer system 300 further comprises a network interface card (NIC) 338 illustratively coupled to the PCI bus 332. The NIC 338 acts as to couple the computer system 300 to a communication network, such the Internet.

Still referring to FIG. 3, computer system 300 may further comprise a super input/output (I/O) controller 340 coupled to the bridge 328 by way of the LPC bus 330. The Super I/O controller 340 controls many computer system functions, for example interfacing with various input and output devices such as a disk drive 334, keyboard 342, a pointing device 344 (e.g., mouse), game controller 346, and various serial ports. The super I/O controller 340 is often referred to as “super” because of the many I/O functions it performs.

The computer system 300 further comprises a graphics processing unit (GPU) 350 coupled to the host bridge 314 by way of bus 352, such as a PCI Express (PCI-E) bus or Advanced Graphics Processing (AGP) bus. Other bus systems, including after-developed bus systems, may be equivalently used. Moreover, the graphics processing unit 350 may alternatively couple to the primary expansion bus 326, or one of the secondary expansion buses (e.g., PCI bus 332).

The graphics processing unit 350 couples to a display device 354 which may comprise any suitable electronic display device upon which any image or text can be displayed. The graphics processing unit 350 comprises one or more onboard processors 356, as well as onboard memory 358. The processor 356 performs graphics processing, as commanded by the main processor 310 (discussed more fully below). Moreover, the memory 358 may be significant, on the order of several hundred megabytes or more. Thus, once commanded by the main processor 310, the graphics processing unit 350 may perform significant calculations regarding graphics to be displayed on the display device, and ultimately display such graphics, without further input or assistance of the main processor 310.

While FIG. 3 shows an illustrative hardware environment, FIG. 4 shows an illustrative software environment 400 within which the various embodiments may operate. At the base of the software environment 400 is an operating system 402, such as a Windows™ operating system from Microsoft Corporation. Menu and interface software 104 overlays operating system 102. Menu and interface software 104 are used to provide various menus and windows to facilitate interaction with the user, and to obtain user input and instructions. Menu and interface software 404 may comprise, for example, Windows™, X Free 86™, and/or MOTIF™.

A basic graphics library 406 overlays menu and interface software 404. Basic graphics library 106 is an application programming interface (API) for computer graphics. The functions performed by basic graphics library 406 may comprise, for example, geometric and raster primitives, viewing and modeling transformations, lighting and shading, hidden surface removal, alpha blending (translucency), anti-aliasing, texture mapping, and atmospheric effects (fog, smoke, haze). A particularly useful basic graphics library 406 is OpenGL™, marketed by Khronos Group of Beaverton, Oreg., and particular OpenGL™ 2.0 and above. The OpenGL™ API is a multi-platform industry standard that is hardware, window, and operating system independent. OpenGL™ is designed to be callable from multiple programming languages, such as C, C++, FORTRAN, Ada and Java.

Visual simulation graphics library 408 overlays the basic graphics library 406. Visual simulation graphics library 408 is an API for creating real-time, multi-processed 3-D visual simulation graphics applications. Visual simulation graphics library 408 provides functions that bundle together graphics library state control functions such as lighting, materials, texture, and transparency. These functions track state and the creation of display lists that can be rendered later. A particularly useful visual simulation graphics library 408 is Open Scene Graph™, which is also available from Khronos Group. OpenSceneGraph™ supports the OpenGL™ graphics library discussed above. Open Scene Graph™ operates in the same manner as OpenGL Performer™, providing programming tools written in C/C++ for a large variety of computer platforms.

A well log rendering program 410 of the various embodiments overlays visual simulation graphics library 408. Program 410 interfaces with, and utilizes the functions carried out by, the visual simulation graphics library 408, basic graphics library 406, menu and interface software 404, and operating system 402. In some embodiments program 410 is written in an object oriented programming language (e.g., C++) to enable the creation and use of objects and object functionality.

Some or all of the software environment 400 may be stored on a long term, non-volatile storage device within computer system 300, such as disk drive 334, and loaded to the main memory 312 during booting and/or initial operation of the computer system 300. In other embodiments, some or all of the software environment may be loaded into the main memory 312 by way of the NIC 338.

A description of the operation of the well log rendering program 410 in accordance with the various embodiments, and in particular how operation of the program 410 differs from related-art well log rendering systems, requires a brief digression into how the related-art systems render the curve 202. In particular, related-art systems render the well log values curve 202 based on a series of underlying geometrical shapes (i.e., underlying geometry), with the geometric shapes in most cases being triangles defined by vertices. The underlying geometry thus creates a wire-frame model of the curve for the well log values.

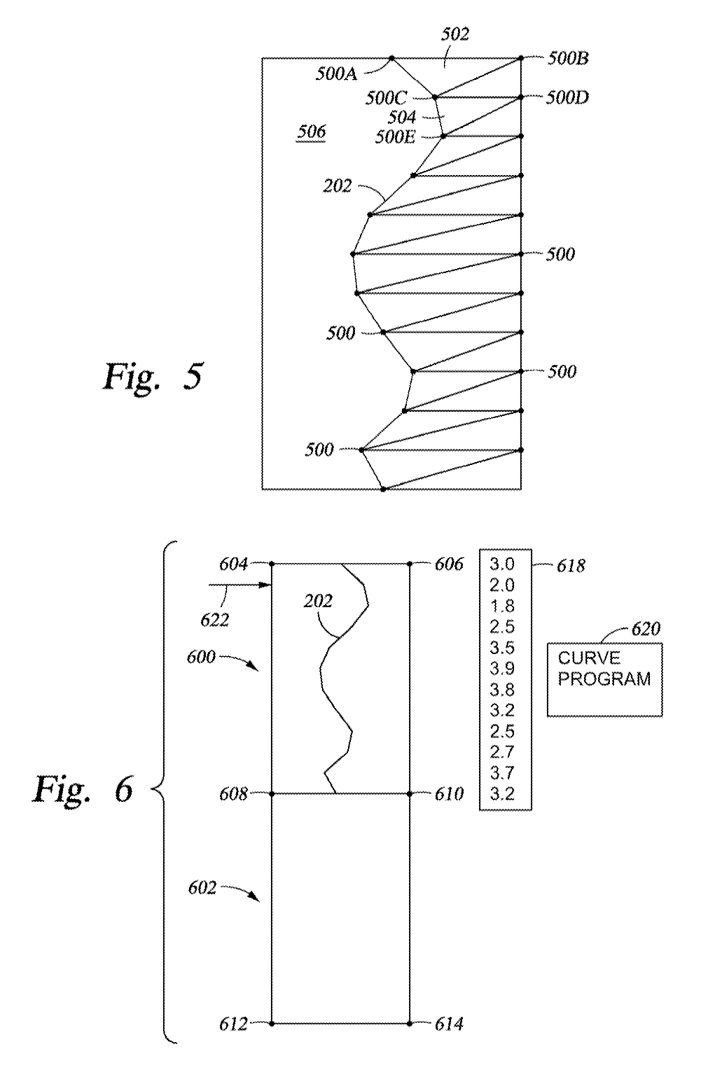

FIG. 5 shows the underlying geometry of log 200 constructed as a series of triangles. In particular, the main processor 310 generates a series of vertices 500 from the underlying well log values. Each illustrative set of three vertices define triangle. For example, vertices 500A, 500B and 500C define a triangle 502. Likewise, vertices 500C, 500D and 500E define triangle 504. All the triangles taken together defines the curve 202. Once the main processor 310 generates some or all the vertices for a particular set of well log values, the main processor 310 sends some or all the vertices to the GPU 350.

Based on the vertices, the GPU 350 renders the curve 202 on the display device 354. In some cases, the GPU merely colors the pixels within each triangle a particular color (e.g., blue), and colors the remaining background 506 a different color (e.g., white) such that the curve 202 is easily recognizable to the human eye. It is noted that the vertices shown in FIG. 5, as well as the lines that define the triangles, are not necessarily visible in the final rendering. With respect to coloring, in other cases (e.g., video games) the wire-frame structure created by the triangles may have a “texture” applied, where the texture may be thought of as a decal that is “pasted” onto the underlying wire frame. For example, the texture could be a brick pattern pasted on to the wire frame to give the appearance of the brick wall. The texture, if used, is also provided to the GPU 350 by the main processor 310. Based on the vertices, textures (if any), and various other pieces of information (e.g., “camera” position) provided by the main processor 310, the GPU 350 renders an image on the display device.

A particular set of well log values may comprise many thousands or hundreds of thousands of data points therein. In creating the vertices used to define the curve of such data points, many hundreds of thousands of vertices may be calculated by the main processor 310 and passed to the GPU 350. In many cases, the vertices used to define the curve for the entire set of well log values may be calculated and provided to the GPU 350 by the main processor 310.

Defining the curve 202 in the manner illustrated by FIG. 5 leads to certainly difficulties. For example, given the enormous amount of data used to represent the curve, the vertices that define the curve 202 for some well log values may require more memory than the capacity of memory 358 of the GPU 350. Relatedly, even if the GPU has sufficient memory for vertices that define a curve 202 for particular set of well log values, there may not be sufficient capacity in the memory 358 for the main processor 310 to provide vertices for multiple sets of well log values that the user would like to view simultaneously.

In accordance with the various embodiments, the curve 202 for a set of well log values is produced without using vertices to define the curve 202. More particularly, in accordance with the various embodiments the log 200 is created by the main processor 310 sending to the GPU vertices that define a “panel.” The main processor 310 also sends well log values to the GPU 350, along with a program to be executed by the processor 356 of the GPU 350 which creates the curve 202 within the panel. The entire well log may thus be created by one or more panels stacked “end-to-end” with the well log values represented by a curve rendered within each panel. The discussion first turns to defining the panels.

In accordance with the various embodiments, each panel is defined by a plurality of vertices, and in some cases each panel is defined by four vertices. FIG. 6 shows two illustrative panels 600 and 602 for purposes of discussion. In particular, panel 600 is defined by four vertices 604, 606, 608 and 610. Likewise, panel 602 is defined by four vertices 608, 610, 612 and 614. While only two panels are shown in FIG. 6, any number of panels may be used to construct an overall well log for a set of well log values. Moreover, while FIG. 6 illustrates using four vertices to define each panel with panels being rectangular, other quadrilateral shapes, and shapes defined with more than four vertices, may be equivalently used. In the alternative, each illustrative set of four vertices may be considered to define two triangles stacked (in the view of FIG. 6) side-by-side.

In accordance with the various embodiments, the panels are indicative of a path of the wellbore from which the well log values were obtained. In the illustrative case of FIG. 6, the underlying wellbore can be considered a vertical portion or non-deviated portion of a wellbore. Stated otherwise, the illustrative case of FIG. 6 each the panel may be considered to be indicative of the path of the underlying wellbore in two dimensions. However, the various embodiments are not limited to the two-dimensional path case, and are also applicable to wellbore paths in three dimensions.

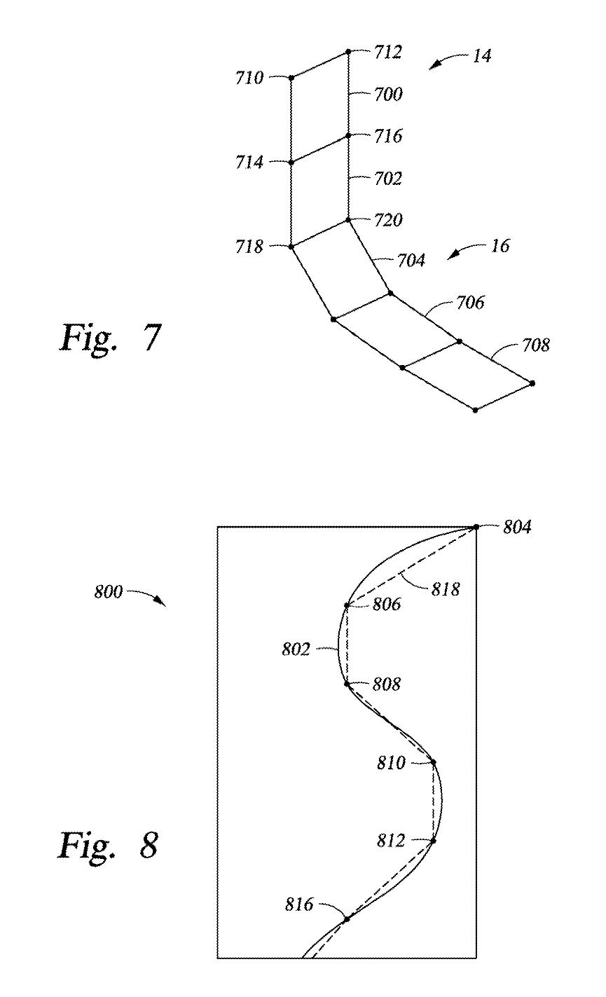

FIG. 7 shows a series of panels such that the panels are indicative of a path of the wellbore in three dimensions. In particular, FIG. 7 shows a series of panels which are indicative of a portion of the wellbore 10 (FIG. 1), and more particularly still the vertical portion 14 transitioning into the deviated portion 16. As illustrated, the portions of the wellbore are represented by five panels 700, 702, 704, 706, and 708. Panel 700 is defined by four vertices 710, 712, 714 and 716. Likewise, panel 702 is defined by four vertices 714, 716, 718 and 720. A similar discussion may be made for the remaining panels being defined by vertices, many of which are shared between panels. Having the panels indicative of the path in three dimensions of the wellbore leads to the illustrative case where the panels are not rectangles when projected onto a two-dimensional surface, such as the paper on which FIG. 7 is shown, or the panel of a display device 354. In accordance with at least some embodiments, the main processor 310 creates the vertices for the one or more panels with vertices being points in any convenient two-dimensional or three-dimensional basis or space, such as the world geodetic coordinate system.

Whether the log is to be shown as a two-dimensional log such as in FIG. 6, or a three-dimensional log (projected onto two dimensions) such as in FIG. 7, once the main processor 310 calculates some or all the vertices, the main processor 310 sends some or all the vertices to the GPU 350. The GPU 350, in turn, creates the panels based on the vertices. It is noted, however, that the neither panels themselves, nor the vertices, are necessarily visible in the final rendering. A curve is rendered within or “on” each panel (discussed more below), and so while a panel may be distinguishable based on the boundaries of the curve or an outline of a selected background color, the various embodiments shall not require that each panel be specifically identifiable in the final rendering. The specification now turns how the main processor 310 provides the well log values to the GPU 350, and how the GPU 350 renders the curve within each panel. While such a discussion may be based on FIG. 7, for convenience the discussion is based on FIG. 6.

In accordance with various embodiments, the well log values for which a curve is to be created within a panel are communicated from the main processor 310 to the GPU 350. Stated otherwise, in accordance with at least some embodiments the actual well log values themselves are communicated from the main processor 310 to the GPU 350. FIG. 6 shows an illustrative one-dimensional array of well log values 618 that may be communicated to the GPU 350, and which one-dimensional array corresponds to the curve 202 in panel 600. The set of well log values 618 are illustrative of any measured parameter associated with the wellbore and/or surrounding formation. For example, the set of well log values 618 may be indicative of gas saturation of the surrounding formation as a function of depth.

In accordance with the embodiments illustrated in FIG. 6, the main processor 310 sends the well log values 618 alone, without any correlation of the well log values 618 to depth. However, each set of well log values 618 is tied logically to a particular panel, and inasmuch as the panel 600 (defined by its vertices) is associated with a depth within the wellbore, the well log values 618 are correlated to depth (and assumed to be equally spaced). In other embodiments, the well log values 618 may be accompanied by depth values, particularly in cases where the assumption regarding equal spacing is not valid.

While there may be many mechanisms by which to send the well log values 618 from the main processor 310 to the GPU 350, in accordance with at least some embodiments the main processor 310 sends the well log values as “texture.” In stating that the main processor 310 sends the well log values as a “texture”, it should be understood that the well log values 618 are not a texture in the sense that the well log values define a texture (e.g., brick) that is to be applied to the panel; rather, the main processor 310 under OpenGL™ model is expected to send a texture file, and in conformance with that expectation the well log values 618 are sent as a texture file. However, the GPU 350 does not accept and apply the texture file containing the well log values 318 as a texture or decal. Instead, the GPU 350 operates with the well log values 618 to create the curve based on a program, also provided by the main processor 310 to the GPU 350.

The GPU 350 in this example discussion now has the vertices that define panel 600 and well log values 618 (from which curve 202 will be constructed). In accordance with the various embodiments, the main processor 310 also sends an executable program 620 to the GPU 350, where the program 620 defines how to create the curve 202 from the well log values 618. In particular, the GPU 350 loads and executes the program 620 in processor 356. The program 620, executed by processor 356, reads the well log values 618 previously provided to the GPU 350 (e.g., reads the well log values 618 from the memory 358 of the GPU 350), and creates the curve 202 within the panel 600. The process continues for each panel currently viewable on the display device 354, with a different set of well log values used for each panel. While the subset of well log values change for each panel, in some embodiments the same program 620 is used by the GPU 350 to determine the curve within each panel. The discussion now turns to illustrative operational characteristics of the program 620.

In at least some embodiments, the program 620 creates a mathematical model for the curve to fit within the panel. In particular, the program 620 determines a scale of the horizontal size of the panels. In some embodiments, the program 620 reads well log values over the entire log (i.e., reads all the well log values sent by the main processor 310, in some cases across multiple “texture” files), determines the maximum and minimum values, and from the maximum and minimum values determines the scale represented by the horizontal size the panels. In other embodiments, particularly embodiments where the main processor 310 does not provide all the well log values to the GPU 350, the main processor 310 sends an indication of the horizontal scale (e.g., sends an indication within each “texture” file, or sends the horizontal scale a single time as a “texture” file).

Regardless of the precise mechanism by which the program 620 determines the horizontal scale, the program 620 then maps the well log values into the panel. For example, each well log value for a particular panel may be assigned a point in the world geodetic coordinate system within the panel, with the “horizontal” location of the point based on the horizontal scale and the particular well log value, and the “depth” location of the point based on the assumed depth (if the well log values are assumed to be equally spaced) or the actual depth if provided by the main processor 310. The well log values are not continuous, and thus in some embodiments the “space” or distance between two points representing the well log values in the panel may be logically spanned by a straight line. Stated otherwise, the value of the mathematical model between well log values is determined by straight-line or linear interpolation. Thus, in some embodiments, the program 620 makes a piece-wise linear curve 202, as illustrated in FIGS. 2 and 6.

The program 620 then selects colors for each pixel of the panel based on the pixel's location relative to the curve of the mathematical model. For example, consider a series of abutting pixels residing on a horizontal row at location 622. In an example implementation, the program 620 may select a left-most pixel, and compare the location of the pixel to the mathematical model of the curve. The first pixel may reside to the left of the mathematical model of the curve 202, and thus may be illuminated with a fill color (e.g., white). The process is repeated for each pixel in the horizontal row, and is repeated for each row in the panel. When a pixel is analyzed that resides on or to the right of the mathematical model, the pixel's color may be selected to be the color of the log (e.g., blue) to distinguish the curve from the fill color. Pixels of the display that reside outside the one or more panels are applied a background color (e.g., black). When completed, the curve will be evident, in this example, as the boundary between the background color (left side of curve 202) against the curve color (right side of curve 202). Using white as a fill color, blue to delineate the curve 202, and black as the background color is merely illustrative, and any color scheme may be equivalently used.

Several points are in order before proceeding. First, creating the curve 202 in the manner described, the underlying geometry for the curve 202 is not represented by vertices defining geometric shapes. Rather, the curve 202 is determined and rendered based on a pixel's location relative the boundary of the mathematical model. Thus, the amount of memory and extent of processing by the GPU 350 to render the illustrative panel 600 is significantly less than if the curve 202 was defined by underlying geometry. Further, in the example curve 202 of FIGS. 2 and 6, the curve 202 is a piece-wise linear curve 202, with “straight line” interpolated values between specific values. Thus, the mathematical model for the curve may be a series of points in the space or basis as determined by the GPU 350 based on the specific well log values. When determining the color of a particular pixel that resides between representations of specific well log values, the program 620 may perform the linear interpolation on-the-fly. In other embodiments, the program 620 may perform the interpolation in advance, such that selecting a color for a pixel is merely a comparison of the pixels effective location in space to the mathematical model.

At sufficiently low resolution (i.e., viewing position of the curve sufficiently far “back”), the curve 202 may look smooth, particularly if there are a large number of well log values displayed within the panel. However, as the view moves closer (stated otherwise, as magnification increases), the piece-wise linear aspect of the curve 202 may become more apparent. In some cases, the piece-wise linear aspect at high magnification may be undesirable, and other embodiments address the undesirability of the piece-wise linear curve using program 620.

In accordance with at least some embodiments, the mathematical model of the curve used to determine a color applied to each pixel within a panel is a more smoothly varying function between specific well log values than the straight-line or linear interpolation discussed above. Stated otherwise, the curve produced within a panel is a more smoothly varying curve, to the extent the resolution of the display device will allow, and as opposed to piece-wise linear. In order to smoothly vary the curve, the program 620 in accordance with these embodiments calculates a smoothly varying mathematical model of the curve associated with the well log values. In accordance with at least some embodiments, the program 620 determines the mathematical model by first determining the points in space that correspond to the well log values as described above, and then calculate values between the points in space that correspond to the well log values by an interpolation method that produces smoothly varying changes, such as cubic interpolation, cosine interpolation, Hermite interpolation.

FIG. 8 shows a panel 800 to illustrate the smoothing of the curve 802 in accordance with particular embodiments. In particular, the smoothly varying curve 802 of FIG. 8 is made of an illustrative six well log values 804, 808, 810, 812 and 816. The straight line interpolation between the points is illustrated in FIG. 8 as dashed line 818. However, in the particular embodiment the values between the points representative of well log values are determined based on a cubic interpolation, leading to a smooth curve 802. Table 1 below shows an illustrative software routine in pseudo-code (roughly equivalent to the C programming language) which may be used to calculate the value between the points 804, 808, 810, 812 and 816.

TABLE 1

double CubicInterpolate (double a0, double a1, double
a2, double a3, double tt){
double A, B, C, D, E, F, c1, c2;
tt2 = tt*tt;
A=(a0+a2−2*a1)*0.5;
B=(a2−a0)*0.5;
C=a1;
D=(a1+a3−2*a2)*0.5;
E=(4*a2−3*a2−a3)*0.5;
F=a1;
c1=A*tt2+Btt+C;
c2=D*tt2+e*tt+F;
return(c1*(1−tt)+c2*tt);
}

Five parameters are passed to the illustrative routine each time the routine is called, the five parameters being four data points representative of four consecutive well log values (i.e., a0, a1, a2 and a3, being in double precision), and tt being a value between 0 and 1 representing an increasing incremental “distance” between points a1 and a2 on each call. The illustrative routine returns a single double precision value representing a cubic interpolated value between points a1 and a2. The routine is called multiple times (with differing values of tt, but with same values of a0, a1, a2 and a3) to interpolate the points between a1 and a2. When interpolating between the next set of data points, three of the previous data point, along with the next consecutive data point, are passed as a0, a1, a2 and a3. Stated otherwise, cubic interpolation uses four data points to make the interpolation between the center two data points. As before, the program 620 may use the illustrative software routine from Table 1 to interpolate on-the-fly when selecting pixel colors, or the program 620 may use the illustrative software routine to determine all the points between points prior to the determination of pixel colors in a panel.

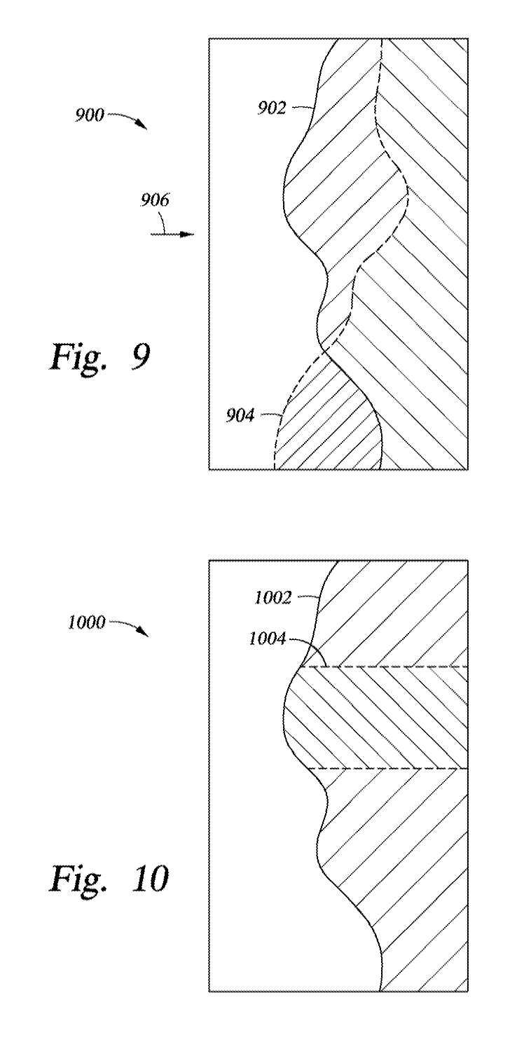

The various embodiments discussed to this point assume that a single curve is created in each panel. However, in accordance with other embodiments, multiple logs may be displayed in a fast and efficient manner. In particular, and considering a single panel with the understanding a log is made of a plurality of consecutive panels, in accordance with a particular embodiment the main processor 310 passes to the GPU 350 vertices for the panel along with multiple sets of well log values (either as single multi-dimensional “texture” file, or perhaps multiple “texture” files), and a program 620 having the capability to render multiple curves in a panel. The GPU 350, executing the program 620, co-renders the curves in the same fashion as discussed above (i.e., without creating underlying geometry). FIG. 9 shows an illustrative panel 900 having two curves 902 and 904 therein. Curve 902 is shown with a solid line and represents a first set of well log values, and curve 904 is shown with a dashed line and represents a second set of well log values. Rendering the curves involves a determination by program 620 regarding each pixel that falls within the panel 900.

In particular, the program 620 in these embodiments makes a mathematical model for each curve 902 and 904 within the panel (e.g., straight line interpolation, cubic interpolation). The program 620 then selects colors for each pixel of the panel based on the pixel's location relative to the mathematical models. For example, consider a series of abutting pixels residing on a horizontal row at location 906. In an example implementation, the program 620 may select a left-most pixel, and compare the location of the pixel to the mathematical models of the curves. The first pixel may reside to the left of both mathematical models, and thus may be illuminated with a fill color (e.g., white). The process is repeated for each pixel in the horizontal row (in this example moving left to right). When a pixel is analyzed that resides on or to the right of the mathematical model for curve 902, but to the left of the mathematical mode for curve 904 (the region shaded upper right to lower left), the pixel's color may be selected to be a first color (e.g., green). When a pixel is analyzed that resides on or to the right of the mathematical model for curve 902, and on or to the right of the mathematical model for curve 904 (the region shaded upper left to lower right), the pixel's color may be selected to be a second color (e.g., blue). The process is repeated for each pixel in the horizontal row, and is repeated for each row within the panel. Pixels of the display that reside outside the one or more panels are applied a background color (e.g., black). When completed, the multiple curves will be evident, and also the relative relationship between the multiple curves. Using white as a fill color, green and blue to delineate the curves, and black as the background color is merely illustrative, and any color scheme may be equivalently used.

While the discussion with to FIG. 9 assumes each set of well log values have a somewhat large range of possible values, well log values may convey information by way of a set of Boolean values. That is, the well log values sent for the second curve could be Boolean values (i.e., zero or one), or another set of predetermined values, to convey information as to the congruence of the first set of well log values and another parameter. For example, the first set of well log values could convey information regarding the ratio of carbon and oxygen sensed in the surrounding formation as a function of depth, while a second set of well log values could identify the presence or absence of a particular formation lithology (e.g., shale). FIG. 10 shows an illustrative panel 1000 having two curves 1002 and 1004 therein. Curve 1002 is shown as a solid line and represents in this example a first set of well log values (e.g., ratio of carbon and oxygen), and curve 1004 is shown as a dashed line and represents a second set of well log values (e.g., formation litholgoy). In the illustrative case of FIG. 10, areas where the curve 1004 is “off”, a first color or texture is plotted to show the curve 1002 (the first color or texture shown by shading upper left to lower right), and in areas where the curves overlap a second color or texture is plotted (shown by shading upper right to lower left). FIG. 10 further shows that when a set of well log values are rendered in an on/off sense, when “on” the curve representing the well log values may use values from another set of well log values so as to track together when “on”. In other embodiments, the on/off set of well log values may extend across the entire panel when “on”. Regardless of the precise mechanism for showing the sets of well log values, by rendering the multiple sets of well log values as in FIG. 10, the congruence of well log values is easily identifiable to the human eye.

Here again, in the illustrative case of two or more sets of well log values, the curves in each panel are rendered based effectively the vertices used to define only the panel itself, and thus amount of memory 358 and computation cycles of the processor 356 to produce the co-rendered curves is significantly less than in situations where the each curve is defined by underlying geometry. Further, while only discussed with respect to a single panel, multiple panels are be stacked end-to-end to create the overall log.

The various embodiments discussed to this point have assumed a single frame on the display device 354 showing one or more panels that simulate the trajectory of the wellbore from a particular viewing position, and which show the one or more curves in each panel. However, the various embodiments also contemplate animating on the display device 354 movement of the viewing position relative to the panels. In particular, the main processor 310 may receive from the viewer or user an indication of a direction to move the display shown in relation to the trajectory (e.g., the indication of the direction t0 move may be received by game controller 346 joystick movement or the keyboard 342). The main processor 310 thus sends a series of viewing position indications to the GPU 350, with the GPU 350 generating an updated two-dimensional projection (a frame update) based on each in the series of viewing position indications. For smooth animation between a starting point and ending point, the main processor 310 should send at least twenty different viewing positions a second, and likewise the GPU 350 updates the two-dimensional projection at least twenty times a second. Faster frame rates provide visually smoother movement “through” the scene.

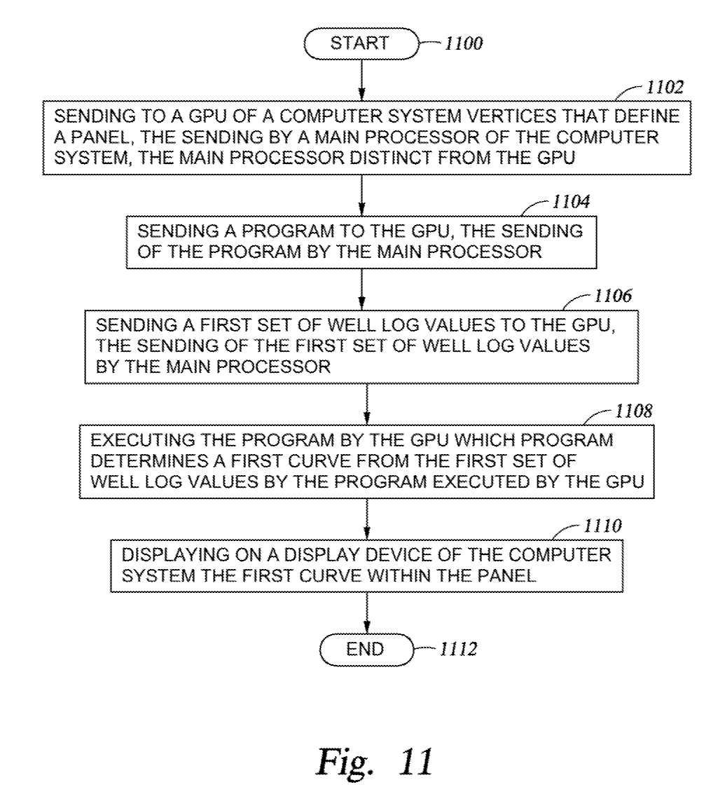

FIG. 11 shows a method in accordance with at least some embodiments. In particular, the method starts (block 1100) and comprises: sending to a GPU of a computer system vertices that define a panel, the sending by a main processor of the computer system, the main processor distinct from the GPU (block 1102); sending a program to the GPU, the sending of the program by the main processor (block 1104); sending a first set of well log values to the GPU, the sending of the first set of well log values by the main processor (block 1106); executing the program by the GPU which program determines a first curve from the first set of well log values by the program executed by the GPU (block 1108); and displaying on a display device of the computer system the first curve within the panel (block 1110). Thereafter, the illustrative method ends (block 1112).

The well log rendering program 410, executed on the main processor 310, merely passes the curve program 620 to the GPU 350. The program 620 passed is not created by well log rendering program 410; rather, the program 620 is created by a programmer in advanced and stored on a memory of the computer system (e.g., disk drive 334). However, in an overall system that has the ability to perform the smoothing of the curves based on the type of interpolation selected by a user, the well log rendering program 410 may selected from multiple versions of program 620 to send to the GPU 350 for the desired case. Moreover, other display-type calculations may be performed by the GPU 350, but have not been discussed so as not to unduly complicate the discussion. For example, the GPU 350 may also perform lighting calculations such as diffuse lighting, ambient lighting and specular lighting, in addition to the calculations to arrive at the rendered curves.

From the description provided herein, those skilled in the art are readily able to combine software created as described with appropriate general-purpose or special-purpose computer hardware (e.g., graphics processing unit) to create a computer system and/or computer subcomponents in accordance with the various embodiments, to create a computer system and/or computer subcomponents for carrying out the methods of the various embodiments, and/or to create a non-transitory computer-readable storage media for storing a software program to implement the method aspects of the various embodiments.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method comprising:
sending to a graphics processing unit (GPU) of a computer system vertices that define a panel, the sending by a main processor of the computer system, the main processor distinct from the GPU;
sending a program to the GPU, the sending of the program by the main processor;
sending a first set of well log values to the GPU, the sending of the first set of well log values by the main processor;
executing the program by the GPU which program determines a first curve from the first set of well log values by the program executed by the GPU; and
displaying on a display device of the computer system the first curve within the panel.

2. The method of claim 1 further comprising wherein executing further comprises executing the program by the GPU which program determines a smooth first curve from the well log values.

3. The method of claim 1 wherein sending vertices further comprises sending vertices that define the panel such that the panel is indicative of a path of a well bore in three dimensions.

4. The method of claim 1 wherein sending vertices further comprises sending vertices that define the panel such that the panel is indicative of a path of the well bore in two dimensions.

5. The method of claim 1 wherein sending the first set of well log values further comprises sending a one dimensional array of well log values.

6. The method of claim 1 further comprising:
sending a second set of well log values to the GPU, the second set of well log values distinct from the first set of well log values, and the sending by the main processor;
executing the program by the GPU which program determines a second curve, distinct from the first curve, the second curve determined from the second set of well log values; and
displaying on the display device both the first and second curves.

7. The method of claim 1 wherein displaying further comprises displaying on the display device the first curve without vertices that define a path of the first curve through the panel.

8. A computer system comprising:
a main processor;
a graphics processing unit (GPU) distinct from the main processor, the GPU coupled to the main processor;
a display device coupled to the GPU;
a memory coupled to the main processor, the memory stores a first program and a second program, and when the first program is executed by the main processor, the first program causes the main processor to:
send to the GPU vertices that define a panel;
send the second program to the GPU; and
send a first set of well log values to the GPU;
wherein, responsive to sending of the second program, the GPU executes the second program, which second program calculates a first curve from the first set of well log values and displays on the display device the first curve within the panel.

9. The computer system of claim 8 wherein the second program, when executed by the GPU, calculates the first curve as a smooth curve from the well log values.

10. The computer system of claim 8 wherein the second program, when executed by the GPU, displays the first curve as piecewise linear.

11. The computer system of claim 8 wherein the first program, when executed by the main processor, causes the main processor to send vertices of the panel where the panel is indicative of a path of a well bore in three dimensions.

12. The computer system of claim 8 wherein the first program, when executed by the main processor, causes the main processor to send vertices of the panel where the panel is indicative of a path of a well bore in two dimensions.

13. The computer system of claim 8 further comprising:
wherein the first program stored on the memory, when executed by the main processor, further causes the processor to send a second set of well log values to the GPU, the second set of well log values distinct from the first set of well log values; and
wherein, responsive to the sending of the second program, the GPU executes the second program, which second program calculates a second curve from the second set of well log values and displays both the first and second curve within the panel.

14. The computer system of claim 8 wherein the second program, when executed by the GPU, causes the GPU to display the first curve without vertices that define a path of the curve.

15. A non-transitory computer-readable medium storing a first program that, when executed by a main processor of a computer system, causes the main processor to:
send to a graphics processing unit (GPU) vertices that define a panel;
send a second program stored on the computer readable medium to the GPU; and
send a first set of well log values to the GPU;
wherein the second program, when executed by the GPU, causes the GPU to:
calculate a first curve from the first set of well log values; and
display on a display device the first curve within the panel.

16. The non-transitory computer-readable medium of claim 15 wherein when the first program causes the main processor to send vertices, the first program further causes the main processor to send vertices of the panel where the panel is indicative of a path of a well bore in three dimensions.

17. The non-transitory computer-readable medium of claim 15 wherein when the first program causes the main processor to send vertices, the first program further causes the main processor to send vertices of the panel where the panel is indicative of a path of a well bore in two dimensions.

18. The non-transitory computer-readable medium of claim 15 wherein when the second program causes the GPU to calculate the first curve, the second program further causes the GPU to calculate a smoothly varying curve.

19. The non-transitory computer-readable medium of claim 15 further comprising:
wherein the first program further causes the processor to send a second set of well log values to the GPU, the second set distinct from the first set of well log values; and
wherein the second program, when executed by the GPU, further causes the GPU to:
calculate a second curve from the second set of well log values; and
display on a display device the second curve within the panel.

20. The non-transitory computer-readable medium of claim 15 wherein when the second program causes the GPU to calculate the first curve, the second program further causes the GPU to calculate the first curve without creating and underlying geometry that defines the first curve.
